(19) United States
(12) Patent Application Publication
(10) Pub. No.: US 2026/0351940 A1
(43) Pub. Date: Nov. 5, 2026

(54) CABLE RETENTION CLAMP

(71) Applicant: PACCAR Inc, Bellevue, WA (US)

(72) Inventors: Bryon Kelling, Bellevue, WA (US); Chase Wolf, Bellevue, WA (US)

(21) Appl. No.: 19/195,290

(22) Filed: Apr. 30, 2025

(51) Int. Cl. H02G 3/32

(52) U.S. Cl. CPC H02G 3/32

(57) ABSTRACT

A clamp system is disclosed, and may comprise a clamp including a first clamp body, a second clamp body, and opposing coupling structures configured to enable the clamp to be movably coupled to a further clamp. The first clamp body and the second clamp body may be configured to be selectively coupleable together in a face-to-face arrangement to define one or more cable or conduit receiving passages extending through the clamp. The opposing coupling structures may be configured to enable a plurality of clamps to be interlinked together in a chain arrangement with each of the plurality of clamps being movably coupled together. The clamp may comprise a mounting structure configured to assist in securing the clamp to a mounting location.

### BACKGROUND

### Technical Field

The present disclosure relates generally to a clamp, and more particularly, but not exclusively, to a clamp capable of retaining cables, conduits, and other like devices.

### Description of the Related Art

Certain clamps are known for use with vehicles, and in particular industrial vehicles and large trucks. For example, clamps are typically used to secure battery cables to the vehicle and prevent movement of the cables during operation of the vehicle. Conventional clamps are a two-part construction with the parts removably coupled to each other. Each part includes channels that cooperate with channels of the other part to define through-going passages for receiving and securing cables when the parts are coupled together. For example, a battery cable clamp may include two such channels in each part to define two through-going passages for securing positive and negative battery cables.

However, cables are prone to fall out of the channels during assembly, which generally makes the clamps more difficult to use and decreases efficiency. This problem is particularly pronounced for battery cables for large industrial vehicles, which are thick and heavy gauge cables. In such a situation, the installer may have difficulty holding and manipulating the cables while also trying to assemble and install the clamp. In addition, the clamps may not control bending of the cables beyond clamps mounted on a base, which may be limited in an assembly. Such uncontrolled bending may further complicate installation of the cables and may lead to damage of the cables.

### BRIEF SUMMARY

Embodiments described herein include cable retention systems (e.g., clamp systems) that are configured to simplify installation of retention structures for cables or conduits. Embodiments described herein may enable installation of additional retention structures to further improve cable or conduit control during installation thereof.

The clamp system includes a clamp having a first clamp body, a second clamp body, and opposing coupling structures configured to enable the clamp to be movably coupled to a further clamp. The first clamp body and the second clamp body are configured to be selectively coupleable together in a face-to-face arrangement to define one or more cable or conduit receiving passages extending through the clamp. The first clamp body may at least partly define the one or more cable or conduit receiving passages and the second clamp body may at least partly define the one or more cable or conduit receiving passages.

In some embodiments, the first clamp body and the second clamp body may be configured to selectively couple together in the face-to-face arrangement by way of at least one snap-fit connection. The first clamp body may include an alignment stud extending from a face thereof and the second clamp body may include an alignment aperture on a face thereof. The alignment aperture may be configured to receive the alignment stud when the first clamp body and the second clamp body are coupled together in the face-to-face arrangement.

In some embodiments, the first clamp body may partially define each of the opposing coupling structures, and the second clamp body may partially define each of the opposing coupling structures. In some embodiments, opposing coupling structures comprise a ball and a socket.

In some embodiments, the cable retention system may include a plurality of clamps interlinked together in a chain arrangement. Each of the plurality of clamps may be movably coupled together. Each of the clamps may be configured to move relative to each other when coupled together with respect to at least one or more rotational degrees of freedom, including three rotational degrees of freedom.

In some embodiments, each clamp may include a mounting structure configured to assist in securing the clamp to a mounting location. The mounting structure may include an axial bore extending through the first clamp body and the second clamp body. The axial bore may be configured to receive a fastener therethrough.

Among other benefits, aspects of the embodiments disclosed herein may provide improved efficiency of installation of cables or conduits, such those used in large industrial vehicles.

### BRIEF DESCRIPTION OF THE SEVERAL VIEWS OF THE DRAWINGS

FIG. 1 shows a perspective view of an example clamp according to an embodiment of the present disclosure.

FIG. 2 shows another perspective view of the clamp of FIG. 1.

FIG. 3 shows a perspective view of an example clamp body of the clamp of FIG. 1.

FIG. 4 shows another perspective view of the clamp body of FIG. 3.

FIG. 5 shows a perspective view of the clamp of FIG. 3 including cables extending therethrough.

FIG. 6 shows a perspective view of the clamp of FIG. 3 including cables extending therethrough mounted on a base.

FIG. 7 shows another perspective view of the clamp of FIG. 6 with cables extending therethrough mounted on the base.

FIG. 8 shows a perspective view of an example clamp system having a plurality of clamps in a chain configuration.

FIG. 9 shows a perspective view of an example clamp system during a coupling process to place the clamp system in a chain configuration.

FIG. 10 shows a perspective view of an example clamp system during a coupling process to place the clamp system in a chain configuration.

FIG. 11 shows a perspective view of an example clamp system during a coupling process to place the clamp system in a chain configuration.

FIG. 12A shows a side view of pitch rotation of a plurality of clamps relative to each other.

FIG. 12B shows a side view of yaw rotation of a plurality of clamps relative to each other.

FIG. 12C shows a side view of roll rotation of a plurality of clamps relative to each other.

FIG. 13 shows a perspective view of an example clamp system having a plurality of clamps in a stacked configuration.

### DETAILED DESCRIPTION

In the following description, certain specific details are set forth in order to provide a thorough understanding of various disclosed embodiments. However, one of ordinary skill in the relevant art will recognize that embodiments may be practiced without one or more of these specific details. In other instances, well-known structures and techniques associated with cable retention clamps may not be shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

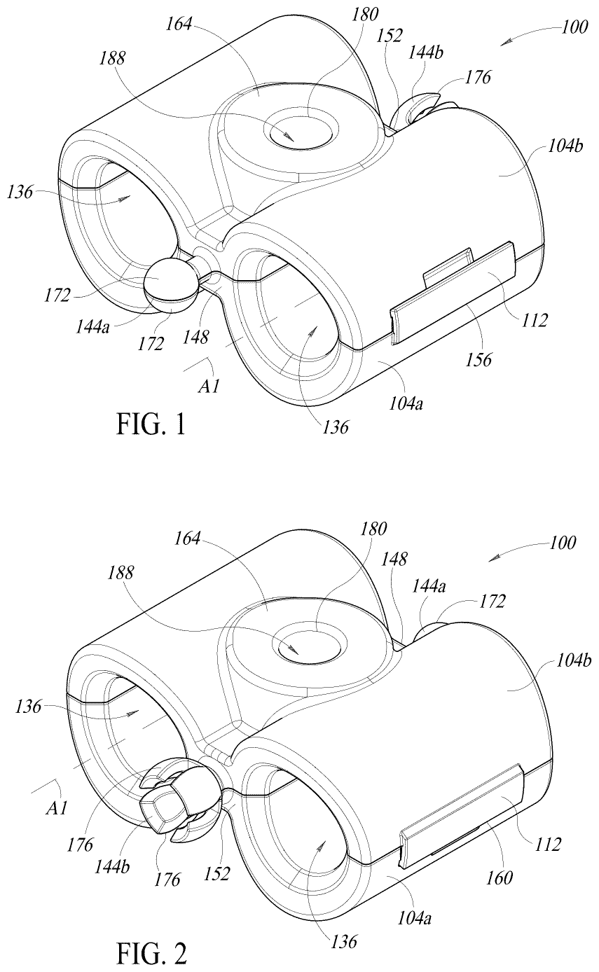

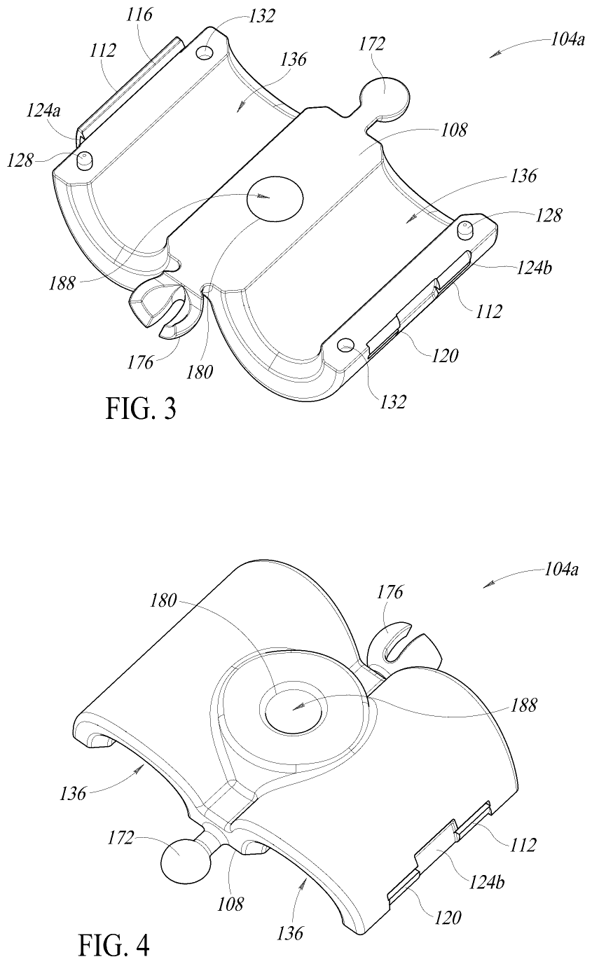

FIGS. 1 and 2 show perspective views of a clamp 100 configured to restrict movement of cables or conduits, such as those included in a motor vehicle. The clamp 100 includes a first clamp body 104a and a second clamp body 104b. The first and second clamp bodies 104a, 104b may be identical, such that the first and second clamp bodies 104a, 104b are interchangeable during assembly of the clamp 100. Accordingly, the description of the first clamp body 104a, which is shown in FIGS. 3 and 4, is equally applicable to the second clamp body 104b. In other embodiments, the first and second clamp bodies 104a, 104b need not be identical, but may include any of the features described below which enable the first and second clamp bodies 104a, 104b to be coupled to each other, to other clamps, and/or to a mounting structure.

With reference to FIGS. 1 through 4, the first and second clamp bodies 104a, 104b are configured to be selectively coupleable together in a face-to-face arrangement, such that a face 108 of the first clamp body 104a is brought into contact with the corresponding face 108 of the opposing second clamp body 104b. The first and second clamp bodies 104a, 104b may be configured to selectively couple together in the face-to-face arrangement by way of at least one connection mechanism 112. The at least one connection mechanism 112 may be a snap-fit connection mechanism. The at least one connection mechanism 112 may be integrally incorporated into the respective clamp body 104a, 104b. For example, in the embodiment shown in FIGS. 1 through 4, the first clamp body 104a includes a male snap-fit component 116 and a female snap-fit component 120 at different locations of the first clamp body 104a. The male snap-fit component 116 of the first clamp body 104a may be configured to be received in the female snap-fit component 120 of the corresponding second clamp body 104b, and the female snap-fit component 120 of the first clamp body 104a may be configured to be received in the male snap-fit component 116 of the corresponding second clamp body 104b. The male snap-fit component 116 and the female snap-fit component 120 may be positioned on opposing sides 124a, 124b of the first and second clamp bodies 104a, 104b, such that when the first and second clamp bodies 104a, 104b are coupled together, the male snap-fit component 116 and the female snap-fit component 120 from the respective first and second clamp bodies 104a, 104b align. During coupling of the first and second clamp bodies 104a, 104b, the first and second clamp bodies 104a, 104b are brought near to each other with the respective faces 108 facing each other. As the first and second clamp bodies 104a, 104b approach each other, the male snap-fit component 116 may elastically deflect until it is received within the female snap-fit component 120. Following the male snap-fit component 116 being received in the female snap-fit component 120, the first and second clamp bodies 104a, 104b are coupled to each other, until the male snap-fit component 116 and/or the female snap-fit component 120 are manipulated to free the male snap-fit component 116 from the female snap-fit component 120.

With continued reference to FIGS. 1 through 4, the first and second clamp bodies 104a, 104b may each include at least one alignment stud 128 extending from the face 108 thereof. The first and second clamp bodies 104a, 104b may include at least one alignment aperture 132 on the face 108 thereof. The at least one alignment aperture 132 may be configured to receive a corresponding alignment stud 128 from the opposing clamp body of the first and second clamp bodies 104a, 104b. Alignment of the at least one alignment stud 128 with the alignment aperture 132 may enable proper alignment of the first and second clamp bodies 104a, 104b with one another when coupling them together.

As shown in FIGS. 3 and 4, the first and second clamp bodies 104a, 104b each may partly define one or more cable or conduit receiving passages 136. When the first and second clamp bodies 104a, 104b are coupled together in the face-to-face arrangement, the first and second clamp bodies 104a, 104b collectively define the one or more cable or conduit receiving passages 136 extending through the clamp 100, as shown in FIGS. 1 and 2.

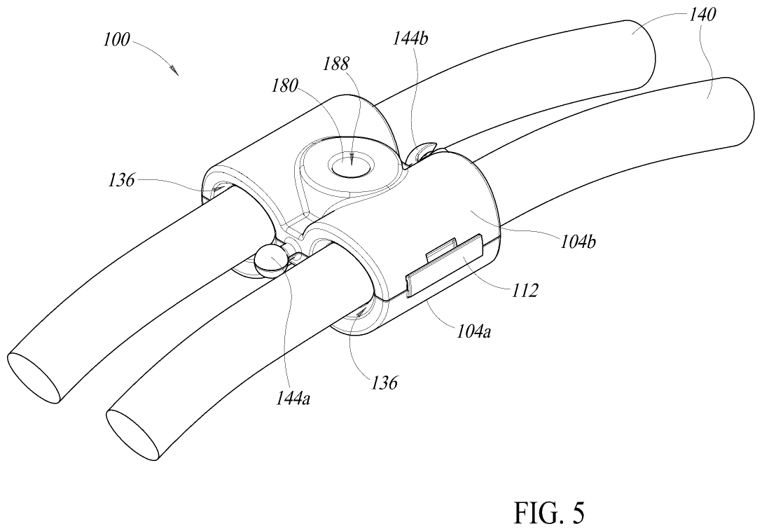

When the first and second clamp bodies 104a, 104b are coupled together, the clamp 100 is configured (e.g., sized) to slidably receive a cable or conduit 140 extending through a cable or conduit receiving passage 136. In embodiments which include more than one cable or conduit receiving passages 136, each cable or conduit receiving passage 136 may slidably receive a cable or conduit 140 extending therethrough, as shown in FIG. 5. In some embodiments, such as the embodiments shown throughout the figures, cable or conduit receiving passages 136 may be parallel to each other to support cables or conduits in a parallel arrangement.

When cable(s) or conduit(s) 140 extend through respective cable or conduit receiving passages 136, the clamp 100 may be configured to move (i.e., slide) along the cable(s) or conduit(s) 140. Accordingly, in some embodiments, the cable(s) or conduit(s) 140 may be inserted into the respective cable or conduit receiving passages 136 following coupling of the first and second clamp bodies 104a, 104b together. Additionally or alternatively, the first and second clamp bodies 104a, 104b may be coupled together when the cable(s) or conduit(s) 140 are positioned in the partially defined cable or conduit receiving passages 136 of one of the first and second clamp bodies 104a, 104b. In such embodiments, the coupling of the first and second clamp bodies 104a, 104b together places the cable(s) or conduit(s) 140 in the respective assembled cable or conduit receiving passages 136 of the clamp 100.

As shown in FIGS. 1 through 5, the clamp 100 may include opposing coupling structures 144a, 144b configured to enable the clamp 100 to be coupled to a further clamp, a base, or the like. In some embodiments, the opposing coupling structures 144a, 144b may be configured to enable the clamp 100 to be moveably coupled to the further clamp, such as another clamp 100 of identical structure. Additionally, a base, such as a component of a large industrial vehicle, may include at least one of the opposing coupling structures 144a, 144b to which the clamp 100 may be coupled.

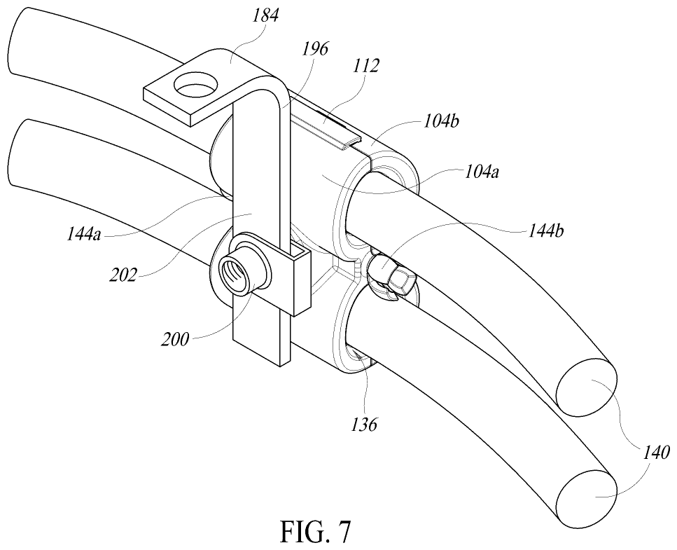

With reference to FIGS. 1 and 2, in some embodiments, the opposing coupling structures 144a, 144b may extend from a first end 148 and a second end 152 of the clamp 100, respectively, such that the opposing coupling structures 144a, 144b extend in a direction parallel with a center axis A1 of at least one of the one or more cable or conduit receiving passages 136. In such embodiments, the opposing coupling structures 144a, 144b may couple the clamp 100 with the further clamp in a chain in parallel with the cable(s) or conduit(s) 140. The clamp 100 coupled with the further clamp in a chain configuration is discussed in further detail with reference to FIGS. 7 through 11 below. Additionally or alternatively, the opposing coupling structures 144a, 144b may extend from any portion of the clamp 100, including but not limited to, a first side 156 and a second side 160 of the clamp 100 and/or a top 164 and a bottom (not visible in FIGS. 1 and 2) of the clamp 100.

With reference to FIGS. 1 through 4, each of the first and second clamp bodies 104a, 104b may at least partially define one or more of the opposing coupling structures 144a, 144b. For example, the clamp body 104a may define a portion 172 of the coupling structure 144a on a first end 148 thereof and/or may define a portion 176 of the coupling structure 144b on a second end 152 thereof. The portion 172 of the coupling structure 144a present on the clamp body 104a may be integrally formed thereon. The portion 176 of the coupling structure 144b may be integrally formed thereon. The portions 172, 176 of the respective coupling structures 144a, 144b may be configured such that the opposing coupling structures 144a, 144b are fully formed when the first and second clamp bodies 104a, 104b are coupled together.

In some embodiments, the opposing coupling structures 144a, 144b may be a ball 144a configured to be received by a socket of another clamp or base and a socket 144b configured to receive the ball of another clamp or base therein. In the embodiment shown throughout the figures, the portion 172 of the ball 144a present on each of the first and second clamp bodies 104a, 104b is half of the ball 144a and the portion 176 of the socket 144b present on each of the first and second clamp bodies 104a, 104b is half of the socket 144b.

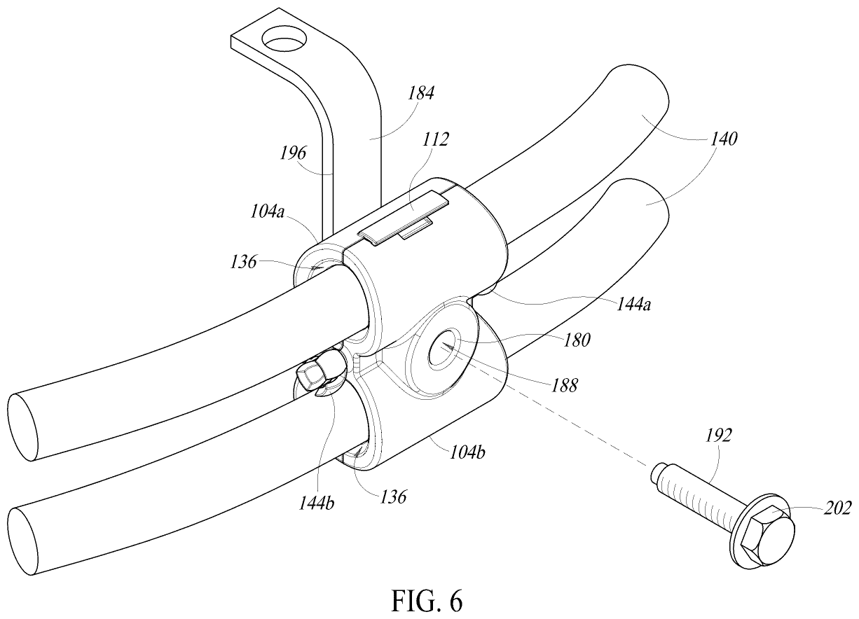

In some embodiments, the clamp 100 may include a mounting structure 180 configured to assist in securing the clamp 100 to a mounting location (i.e., a base) 184, as shown in FIGS. 6 and 7. The mounting location 184 may be positioned on any desirable location, including on positions throughout large industrial vehicles. The mounting structure 180 of the clamp 100 may include an axial bore 188 extending through at least one of the first and second clamp bodies 104a, 104b. In some embodiments, such as the embodiment shown throughout the figures, the axial bore 188 may extend through both of the first and second clamp bodies 104a, 104b such that the axial bore 188 is continuous through both the first and second clamp bodies 104a, 104b. With reference to FIGS. 6 and 7, the axial bore 188 may be configured to receive a fastener 192 therethrough. The fastener 192 may be a screw or a bolt. The mounting structure 180 of the clamp 100 may be configured such that the cable(s) or conduit(s) 140 may extend between the one or more cable or conduit receiving passages 136 when the fastener 192 extends through the mounting structure 180.

The mounting location 184 to which the clamp 100 may be coupled to may include a mounting support 196 and a spring clip nut 200 on the mounting support 196, as shown in FIG. 7. To mount the clamp 100 to the mounting location, the fastener 192 may extend through the axial bore 188 of the mounting structure 180 of the clamp 100 and engage the spring clip nut 200 on the mounting support 196. The spring clip nut 200 may be positioned with threads thereof on a side 202 of the mounting support 196 opposite the clamp 100. As the fastener 192 is threaded into the spring clip nut 200, the clamp 100 is fastened to the mounting support 196 by way of being positioned between the mounting support 196 and a head 202 of the fastener 192.

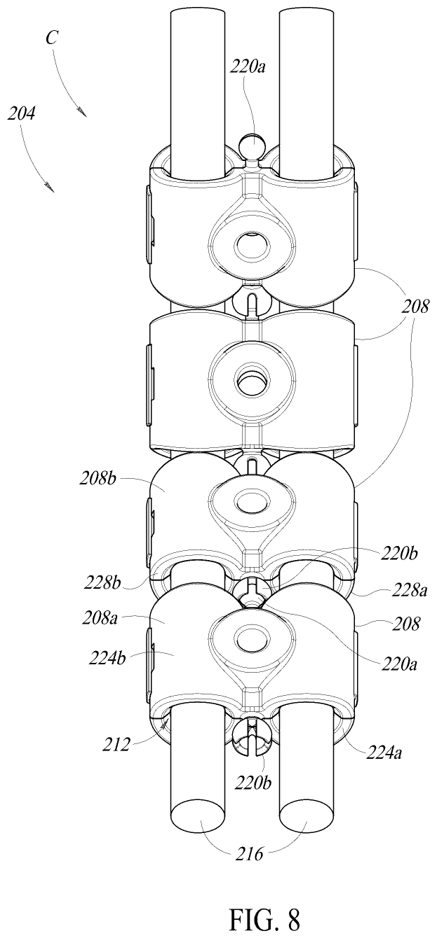

FIG. 8 shows a clamp system 204 comprising a plurality of clamps 208 arranged in a chain configuration C. Each clamp of the plurality of clamps 208 shown in FIG. 8 is clamp 100 described above, though the use of clamp 100 is not required. Each clamp of the plurality of clamps 208 includes one or more cable or conduit receiving passages 212 extending therethrough. In an advantageous embodiment, each clamp of the plurality of clamps 208 includes the same number of cable or conduit receiving passages 212. In such embodiments, the plurality of clamps 208 may be arranged such that the cable(s) or conduit(s) 216 extend through the one or more cable or conduit receiving passages 212 of each clamp of the plurality of clamps 208.

In other embodiments, one or more clamps of the plurality of clamps 208 may differ in the number cable or conduit receiving passages 212 extending therethrough. In such embodiments, a cable or conduit 216 may bypass one or more clamps of the plurality of clamps 208.

The plurality of clamps 208 may be coupled to one another by way of opposing coupling structures 220a, 220b present on each clamp of the plurality of clamps 208. The opposing coupling structures 220a, 220b may enable the plurality of clamps 208 to be interlinked together in the chain configuration C. Such coupling may be accomplished by receipt of a male coupling structure 220a of a first clamp 208a of the plurality of clamps 208 into a female coupling structure 220b of a second clamp 208b of the plurality of clamps 208. In the embodiment shown in FIG. 8, the male coupling structure 220a is a ball and the female coupling structure 220b is a socket configured to receive the ball of the male coupling structure 220a. The ball 220a of the first clamp 208a is configured to be received in the socket 220b of the second clamp 208b. The receipt of the ball 220a of the first clamp 208a in the socket 220b of the second clamp 208b couples the first clamp 208a to the second clamp 208b.

In some embodiments, the opposing coupling structures 220a, 220b may only couple to each other when first and second clamp bodies 224a, 224b of the first clamp 208a are coupled together and when first and second clamp bodies 228a, 228b of the second clamp 208b are coupled together. For example, the male coupling structure 220a of the first clamp 208a may be inserted into the female coupling structure 220b of the second clamp 208b when both opposing coupling structures 220a, 220b have been formed by coupling of the respective first and second clamp bodies 224a, 224b, 228a, 228b of the first clamp 208a and the second clamp 208b. In the embodiment shown in FIG. 8, the ball 220a may be inserted into the socket 220b to couple the first clamp 208a and the second clamp 208b. The socket 220b may be elastically deformable such that the socket 220b may radially deform to enable the ball 220a to be inserted into the socket 220b.

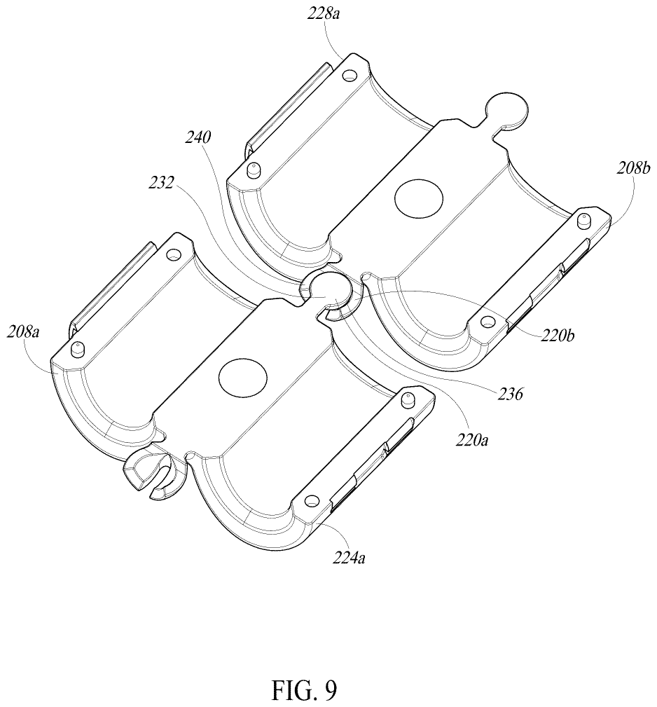

Additionally or alternatively, coupling of the opposing coupling structures 220a, 220b may occur during coupling of the first and second clamp bodies 224a, 224b, 228a, 228b of at least one of the first clamp 208a and the second clamp 208b. Such a coupling process is shown in FIGS. 9 through 11. For example, the first clamp body 224a of the first clamp 208a may be positioned such that a portion 232 of the male coupling structure 220a of the first clamp body 224a of the first clamp 208a is in a space 236 defined by a portion 240 of the female coupling structure 220b of the first clamp body 228a of the second clamp 208b, as shown in FIG. 9.

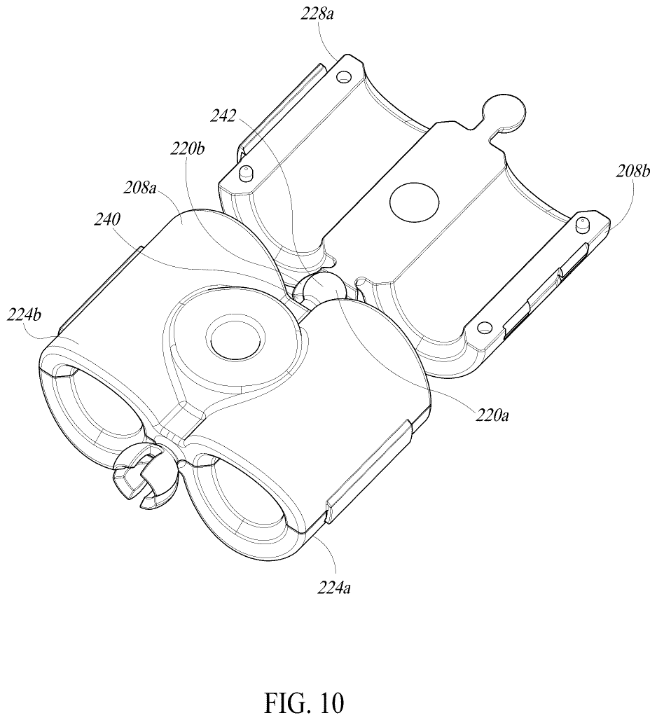

Next, the second clamp body 224b of the first clamp 208a may be coupled to the first clamp body 224a of the first clamp 208a, as shown in FIG. 10. When the first and second clamp bodies 224a, 224b of the first clamp 208a are coupled together, the portion 232 of the male coupling structure 220a of the first clamp body 224a of the first clamp 208a may remain in the space 236 defined by the portion 240 of the female coupling structure 220b of the first clamp body 228a of the second clamp 208b, while a portion 242 of the male coupling structure 220a of the first clamp body 224a is adjacent thereto. The male coupling structure 220a of the first clamp 208a is assembled by way of the coupling of the first and second clamp bodies 224a, 224b of the first clamp 208a.

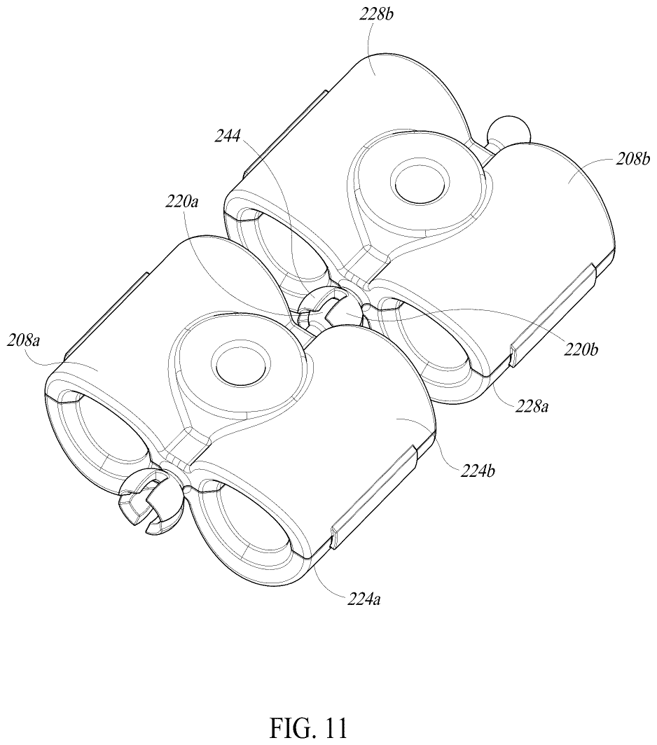

In the next step, the second clamp body 228b of the second clamp 208b may be coupled to the first clamp body 228a of the second clamp 208b, as shown in FIG. 11. Coupling of the first and second clamp bodies 228a, 228b of the second clamp 208b places a portion 244 of the female coupling structure 220b of the second clamp 208b partially around the male coupling structure 220a of the first clamp 208a. The female coupling structure 220b of the second clamp 208b is assembled by way of the coupling of the first and second clamp bodies 228a, 228b of the second clamp 208b. When assembling the female coupling structure 220b of the second clamp 208b in such a way, the female coupling structure 220b of the second clamp 208b receives, and is coupled to, the male coupling structure 220a of the first clamp 208a immediately following coupling of the first and second clamp bodies 228a, 228b of the second clamp 208b.

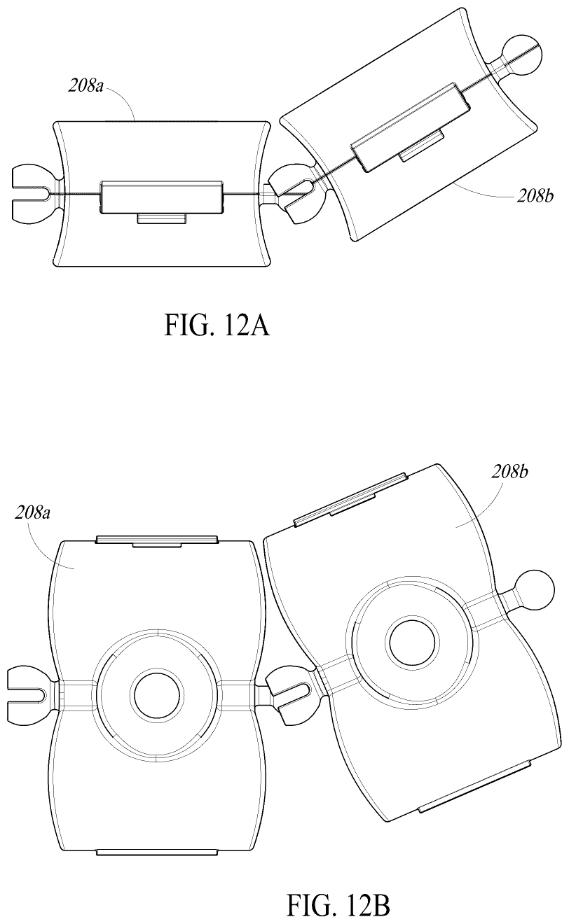

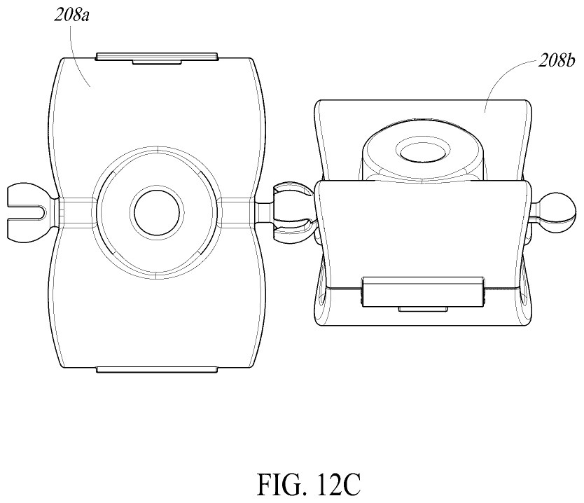

When coupled together in the chain configuration C shown in FIGS. 8 and 11, the first and second clamps 208a, 208b may be configured to move relative to each other with respect to at least one rotational degree of freedom. When coupled together in the chain configuration C, the first and second clamps 208a, 208b may be configured to move relative to each other with respect to each of three different rotational degrees of freedom. When coupled together in the chain configuration C, the first and second clamps 208a, 208b may be configured to pitch (shown in FIG. 12A), yaw (shown in FIG. 12B) and roll (shown in FIG. 12C) relative to each other. The opposing coupling elements 220a, 220b may be configured to enable such movement of the first and second clamps 208a, 208b relative to each other. For example, when the opposing coupling elements 220a, 220b comprise a ball and a socket, respectively, the ball 220a may be rotatable about at least one axis when received in the socket 220b.

The first clamp 208a and/or the second clamp 208b may be configured to limit movement therebetween when the first clamp 208a and the second clamp 208b are coupled together. For example, the first clamp 208a and/or the second clamp 208b may be configured to limit pitch of the first clamp 208a relative to the second clamp 208b. Such limiting may be accomplished by the shape of the first clamp 208a and/or the second clamp 208b, by way of the first clamp 208a contacting the second clamp 208b at a limit of movement. In other embodiments, the opposing coupling structures 220a, 220b may be configured to limit the amount of movement between the first clamp 208a and the second clamp 208b in at least one direction.

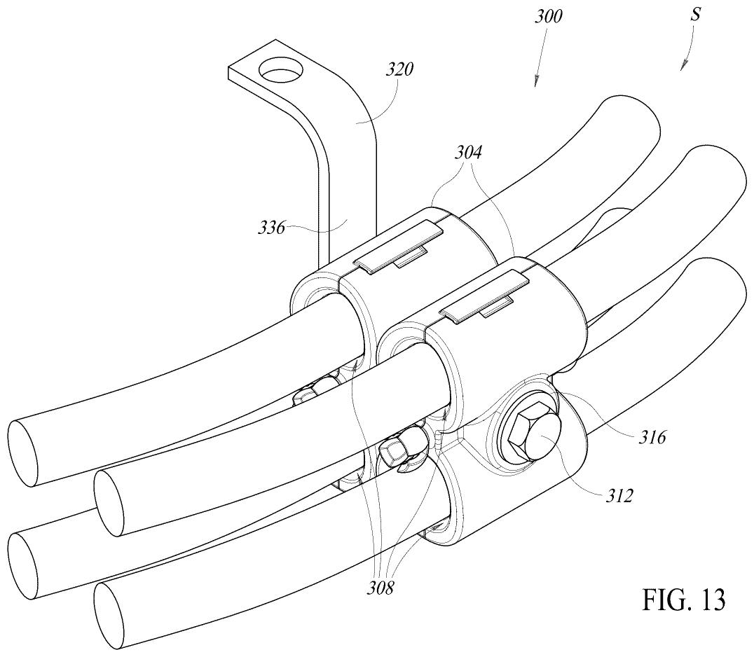

FIG. 13 shows a clamp system 300 comprising a plurality of clamps 304 arranged in a stacked configuration S. Each clamp of the plurality of clamps 304 shown in FIG. 13 is clamp 100 as described above, though the use of clamp 100 is not required. Each clamp of the plurality of clamps 304 includes one or more one or more cable or conduit receiving passages 308 extending therethrough.

The plurality of clamps 304 may be coupled to one another by way of a fastener 312 extending through a mounting structure 316 of each of the plurality of clamps 304 and the fastener 312 being coupled to a mounting support 320. The mounting structure 316 of each of the plurality of clamps 304 is an axial bore (not visible)extending therethrough. The fastener 312 may engage a spring clip nut (not visible) coupled to the mounting support 320. A threaded portion of the spring clip nut is positions on a backside of the mounting support 320 opposite a clamp side 336 of the mounting support 320. As the fastener 312 is threaded into the spring clip nut, the plurality of clamps 304 may be fastened to the mounting support 320 and to each other in the stacked configuration S.

The clamps and associated systems described herein may be adapted to a variety of implementations, including those not related to industrial vehicles or trucks. Such clamps may provide improved efficiency when installing cables and may provide improved control over guiding of cables throughout assemblies.

The devices and systems of the disclosure each have several innovative aspects, no single one of which is solely responsible or required for the desirable attributes disclosed herein. The various features described above may be used independently of one another, or may be combined in various ways. All possible combinations and subcombinations are intended to fall within the scope of this disclosure. Various modifications to the implementations described in this disclosure may be readily apparent to those of ordinary skill in the relevant art, and the generic principles defined herein may be applied to other implementations. Thus, the claims are not intended to be limited to the implementations shown herein, but are to be accorded the widest scope consistent with this disclosure, the principles and the novel features disclosed herein.

Certain features that may be described in this specification in the context of separate implementations also may be implemented in combination in a single implementation. Conversely, various features that may be described in the context of a single implementation also may be implemented in multiple implementations separately or in any suitable subcombination. Moreover, although features may be described above as acting in certain combinations and even initially claimed as such, one or more features from a claimed combination can be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

In general, in the following claims, the terms used should not be construed to limit the claims to the specific embodiments disclosed in the specification and the claims, but should be construed to include all possible embodiments along with the full scope of equivalents to which such claims are entitled.

1. A clamp system, comprising:
a clamp including:
a first clamp body;
a second clamp body; and
opposing coupling structures configured to enable the clamp to be movably coupled to a further clamp,
wherein the first clamp body and the second clamp body are configured to be selectively coupleable together in a face-to-face arrangement to define one or more cable or conduit receiving passages extending through the clamp.

2. The clamp system of claim 1, wherein the first clamp body partly defines the one or more cable or conduit receiving passages, and wherein the second clamp body partly defines the one or more cable or conduit receiving passages.

3. The clamp system of claim 1, wherein the first clamp body and the second clamp body are configured to selectively couple together in the face-to-face arrangement by way of at least one snap-fit connection.

4. The clamp system of claim 1, wherein the first clamp body partially defines each of the opposing coupling structures, and wherein the second clamp body partially defines each of the opposing coupling structures.

5. The clamp system of claim 1, wherein the first clamp body includes an alignment stud extending from a face thereof, and
wherein the second clamp body includes an alignment aperture on a face thereof, the alignment aperture configured to receive the alignment stud when the first clamp body and the second clamp body are coupled together in the face-to-face arrangement.

6. The clamp system of claim 1, wherein the opposing coupling structures comprise a ball and a socket.

7. The clamp system of claim 1, further comprising:
a supplemental clamp including:
a first clamp body;
a second clamp body;
opposing coupling structures configured to enable the supplemental clamp to be movably coupled to the clamp,
wherein the first clamp body of the supplemental clamp and the second clamp body of the supplemental clamp are configured to be selectively coupleable together in a face-to-face arrangement to define one or more cable or conduit receiving passages extending through the supplemental clamp.

8. The clamp system of claim 7, wherein the clamp and the supplemental clamp are coupled together in a chain arrangement by way of a respective one of the opposing coupling structures of the clamp and the supplemental clamp.

9. The clamp system of claim 8, wherein the clamp and the supplemental clamp are configured to move relative to each other when coupled together with respect to at least one rotational degree of freedom.

10. (canceled)

11. (canceled)

12. The clamp system of claim 9, wherein the clamp and the supplemental clamp are configured such that movement is limited between clamp and the supplement clamp when coupled together.

13. (canceled)

14. (canceled)

15. The clamp system of claim 1, wherein the clamp is configured to slidably receive a cable or conduit extending through one of the one or more cable or conduit receiving passages when the first clamp body and the second clamp body are coupled together about the cable or conduit during use.

16. The clamp system of claim 1, wherein the clamp includes a mounting structure configured to assist in securing the clamp to a mounting location.

17. (canceled)

18. (canceled)

19. The clamp system of claim 1, wherein a respective first portion of each of the opposing coupling structures is integrally formed in the first clamp body, and wherein a respective second portion of each of the opposing coupling structures is integrally formed in the second clamp body.

20. The clamp system of claim 1, wherein the first clamp body and the second clamp body are configured to be selectively coupleable together in the face-to-face arrangement to define a pair cable or conduit receiving passages extending through the clamp in a parallel arrangement.

21. A cable or conduit retention system comprising:
a plurality of clamps each defining one or more cable or conduit receiving passages extending therethrough, each clamp including:
opposing coupling structures configured to enable the plurality of clamps to be interlinked together in a chain arrangement with each of the plurality of clamps being movably coupled together, and
a mounting structure configured to assist in securing the clamp to a mounting location.

22. The cable or conduit retention system of claim 21, wherein the opposing coupling structures of each clamp comprise a ball and a socket.

23. The cable or conduit retention system of claim 21, wherein the plurality of clamps are configured such that adjacent clamps can move relative to each other when coupled together with respect to at least one rotational degree of freedom.

24. (canceled)

25. (canceled)

26. The cable or conduit retention system of claim 23, wherein the plurality of clamps are configured such that rotational movement is limited between adjacent clamps when coupled together.

27. The cable or conduit retention system of claim 21, wherein each clamp of the plurality of clamps is configured to slidably receive a cable or conduit extending through one of the one or more cable or conduit receiving passages of the clamp during use.

28. The cable or conduit retention system of claim 27, wherein, during use, the plurality of clamps are arranged such that the cable or conduit extends through a respective one of the one or more cable or conduit receiving passages of each clamp in series.

29-32. (canceled)
